(19) United States
(12) Patent Application Publication
(10) Pub. No.: US 2008/0152471 A1
(43) Pub. Date: Jun. 26, 2008

(54) Method and Assembly For Shifting the Fork Cradle of a Forklift Truck Laterally and For Tilting it Longitudinally

(76) Inventor: Janne Polvilampi, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/664,537

(22) PCT Filed: Oct. 3, 2005
(86) PCT No.: PCT/FI05/00420

§ 371 Date: Sep. 12, 2007

(30) Foreign Application Priority Data
Oct. 1, 2004 (FI) 20041280

(51) Int. Cl. B66F 9/14; B66F 9/16

(52) U.S. Cl. 414/671; 414/668

(57) ABSTRACT

The invention relates to an assembly formed by the hoisting cradle (4) and the fork cradle (2) of a forklift truck (1), in which the fork cradle (2) consists of two vertical beams (11, 12) and two horizontal beams (9, 10), the beams (9, 10, 11, 12) forming a substantially rectangular construction, to which hoisting means (3) are attached, the hoisting cradle (4) consisting of two substantially vertical beams (7, 8), one substantially transverse beam (5) and at least one substantially transverse hydraulic cylinder (6), the lower surface (14) of the upper horizontal beam (9) of the fork cradle (2) matching the curved outer surface (13) of the hydraulic cylinder (6), with bearings provided between the surfaces (13, 14). The invention also relates to a corresponding method for transverse shifting of a, fork cradle.

The invention relates to the fork cradle of a forklift truck. More specifically, the invention relates to a method and an assembly for moving the fork cradle of a forklift truck transversely in the horizontal plane and for tilting it in the direction of movement of the forklift truck.

To facilitate the drive of a forklift truck, it is often necessary to shift the fork cradle of a forklift truck transversely. The fork cradle is shifted while being journalled in the hoisting cradle and the transverse movement is generated by means of an actuating cylinder. To this end, a plurality of mechanisms and assemblies have been developed with a view to allowing such transverse movement, while the truck frame and the hoisting cradle remain stationary. Such additional structures in the construction of the hoisting cradle of a forklift truck will result in an increased number of transverse beams and transverse cylinders in the front part of the truck. Such transverse structures frequently cause considerable obstruction of the truck driver's field of view. They often cover specifically the crucial part of his field of view, i.e. the area where the truck is driven for lifting the load, and while the load is lifted, the beams move precisely in this crucial area of the field of view. Simultaneously with the horizontal movement of the fork cradle of the truck, it is often necessary to incline the fork cradle in the direction of movement of the truck.

Such prior art assemblies for transverse movement of the forklift cradle of a truck have been disclosed e.g. by the following references: GB 2 099 787 A, DE 100 57 239 A1, WO 03/070617 A1 and U.S. Pat. No. 5,807,060.

GB 2 099 787 A discloses a solution, in which a separate arm has been fixed within the area of one end of a cylinder used for transverse movement of a fork cradle, the fork cradle being mountable with its groove-like upper structure on top of this arm. The separate arm is supported on the remaining construction with the other end alone. The actuating cylinder actuates the fork cradle in the transverse direction by bearing against a lug in the fork cradle, and the fork cradle moves slidingly on the separate arm mentioned above. The use of the actuating cylinder generates a moment in the construction, given the specific distance between the force vector of the actuating cylinder (the longitudinal axis of the cylinder) and the separate arm allowing transverse movement, including its bearings. This solution leads to a very high moment, given the relatively long distance between the bearings and the force vector.

DE 100 57 239 A1 discloses a solution, in which a separate round bar has been welded on top of the actuating cylinder, with the transverse beam of the fork cradle moving on the bar.

In addition, a separate slide block has been mounted between the bar and the fork cradle. The reference also discloses another optional embodiment, in which a transverse body with a groove has been connected on top of the cylinder. Balls have been mounted in the groove, and on top of the balls a fork cradle has been mounted with a matching groove in its transverse beam for accommodating the movement of the balls. In other words, bearings have been carried out with the aid of detached balls in alignment. These two solutions both result in a moment that is slightly lower than that of the solution in GB 2 099 787 A, because the bearings are located closer to the force vector than in the preceding solution.

WO 03/070617 A1 discloses the construction of a hoisting cradle, in which machined locations within a transverse beam have been provided for the actuating cylinders. The two cylinders actuate the fork cradle in a reciprocating movement in the transverse direction. On top of the transverse beam of the hoisting cradle, a planar projection has been provided to match the groove in the transverse beam of the fork cradle. The bearings preferably consist of slide bearings in this case. Due to the demanding milling operations, this solution has very costly manufacture, and what is more, the generated moment is of the same order as that of the solution disclosed in DE 100 57 239 A1 mentioned above.

U.S. Pat. No. 5,807,060 discloses a solution for transverse shifting of a fork cradle, in which the fork cradle moves mounted on bearings on a separate transverse beam, which, in turn, is connected to the actuating cylinder on top of the actuating cylinder. The specific aim of this solution is a minimum size and a straightforward solution with a view to enlarging the driver's field of view. In fact, there are less structures remaining in the driver's field of view compared to GB 2 099 787 A. However, the parts on top of the actuating cylinder, such as the transverse beam and the bearing means, cause additional obstruction of the driver's field of view. Also, as the construction is assembled from a plurality of parts, it has a costly design that is susceptible to damage. The moment generated in this case is of the same order as that of the solutions disclosed in DE 100 57 239 A1 and WO 03/070617 A1 mentioned above.

For driving safety and work ergonomic reasons, it is important to develop a method and an assembly that do not substantially increase the blind area of the driver's field of view, while still allowing transverse shifting of the fork cradle of the truck.

The prior art solutions mentioned above differ from that of the invention, while allowing transverse movement of the fork cradle by utilising a different structural solution. Nevertheless, the solutions above do not allow simultaneous tilting about the axis of the same cylinder as the one used for transverse movement of the fork cradle.

The solution of the invention enables a combination of these two operations by disposing the fork cradle in movement directly on the actuating cylinder, without separate supplementary transverse beams in the hoisting cradle and by incorporating actuating cylinders in the construction to generate tilting. The invention is characterised by the features defined in the characterising part of the independent claims.

The invention achieves a very economical solution, which reduces the blind sector of the driver's field of view appreciably. It also provides a simpler design with easier maintenance. At the same time, it leads to a minimum distance between the force vector of the actuating cylinder and the bearings of the fork/hoisting cradle, so that the moment generated by bearings is also minimised. A design allowing the use of the same axis for lateral movement of the fork cradle and for tilting the forklift truck in its direction of movement lead to considerably simpler and lighter structures of the assembly.

The invention is explained in greater detail below with reference to the accompanying drawings, in which

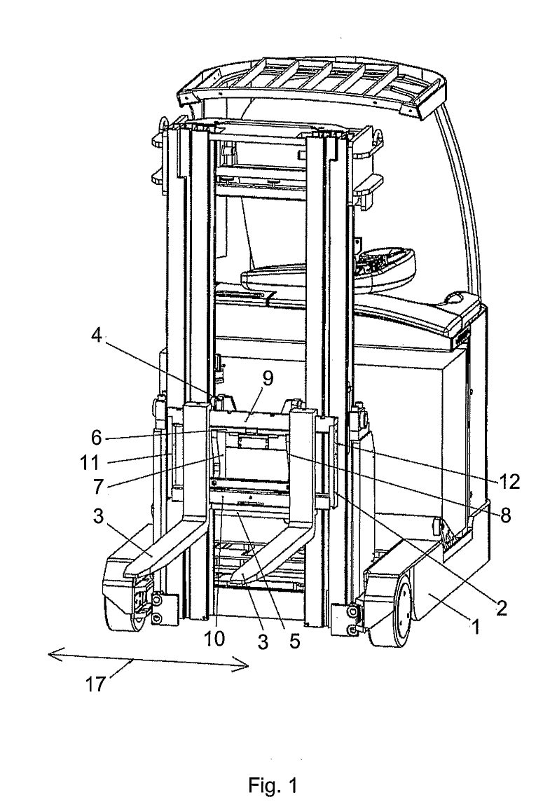

FIG. 1 shows the construction of the fork/hoisting cradle of the invention when mounted in a forklift truck,

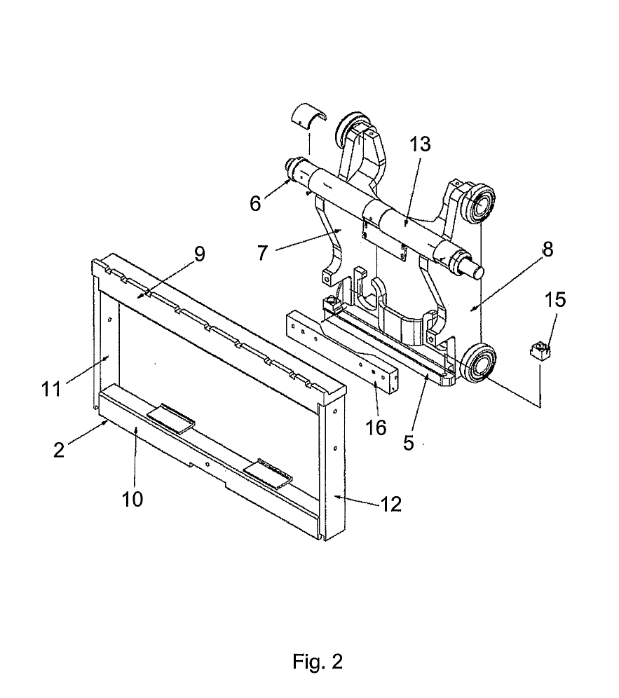

FIG. 2 is an exploded view of a combined fork/hoisting cradle construction of the invention,

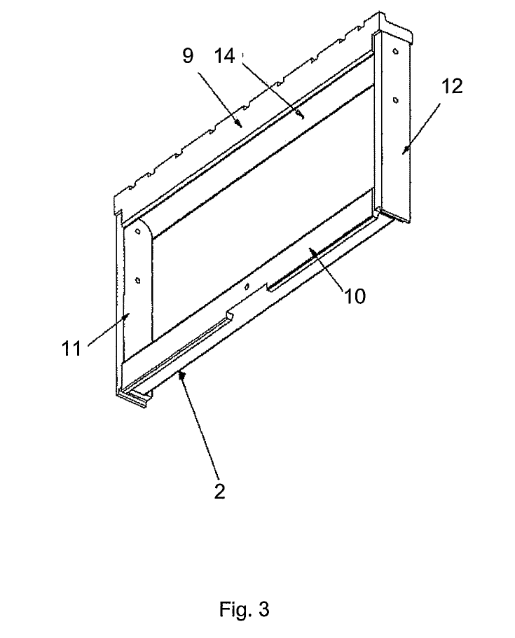

FIG. 3 is an oblique bottom view of the fork cradle, and

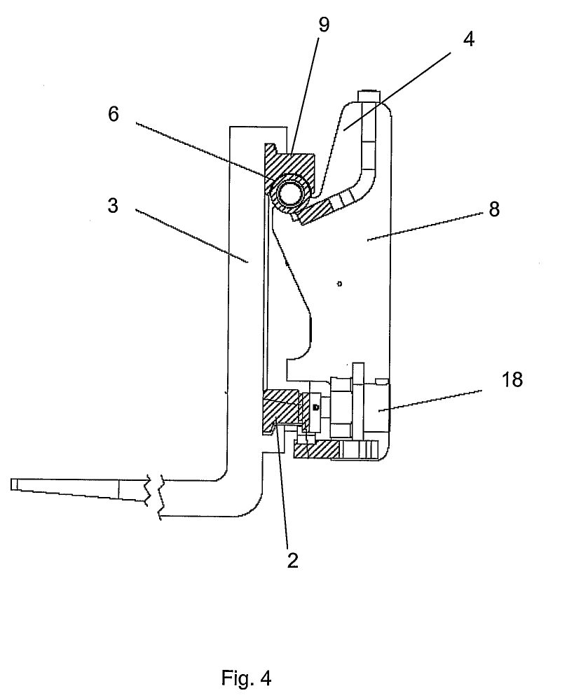

FIG. 4 shows the construction of a fork/hoisting cradle comprising an assembly to allow tilting of the fork cradle in the direction of movement of the forklift truck.

FIG. 1 illustrates a forklift truck 1 comprising the solution of the invention for transverse shifting of the fork cradle 2. In this context, transverse direction implies shifting the fork cradle 2 transversely to the horizontal direction defined by the hoisting means, i.e. the hoisting forks 3, of the forklift truck 1. The transverse direction into which the fork cradle 2 is moved is marked with an arrow 17 in FIG. 1. The hoisting cradle 4 consists of a transverse beam 5 and a cylinder 6, and of two vertical beams 7 and 8. The beams 9, 10, 11 and 12 form a substantially planar rectangle, the fork cradle 2, with the hoisting forks 3 of the forklift truck 1 being attachable to the upper transverse beam 9 of this cradle. The hoisting cradles 3 may be solidly mounted in the fork cradle 2 or their position can be changed if desired. The position may be changed either manually or e.g. by hydraulic means.

The fork cradle 2 is transversely shifted preferably by means of a hydraulic cylinder 6. This hydraulic cylinder 6 is fixed solidly e.g. by welding to the vertical beams 7 and 8 of the hoisting cradle 4. There may be one or two hydraulic cylinders 6. If the assembly comprises two hydraulic cylinders 6, they are mounted with their ends abutting, forming one monolithic longitudinal body.

FIG. 2 is a more detailed exploded view of the structure of the hoisting cradle 4 and the fork cradle 2. The transversely moving fork cradle 2 is mounted so as to move directly on the hydraulic cylinder 6. In this case, the curved surface 13 of the hydraulic cylinder 6 only requires machining so as to form a bearing surface or the mounting surface of a bearing. The bearings preferably comprise e.g. slide bearings. The bearing surface or the mounting surface of the bearing consists of the curved upper surface 13 of the hydraulic cylinder, so that the entire surface of the cylinder 6 does not require machining. The area to be machined comprises 30-70% of the outer surface of the hydraulic cylinder 6 in its peripheral direction. it preferably comprises 40-60% and very advantageously 45-55% of the outer surface of the hydraulic cylinder 6. The fork cradle 2 can be mounted directly on the hydraulic cylinder 6 by means of the upper transverse beam 9 of the fork cradle 2. A groove 14 matching the curved outer surface 13 of the hydraulic cylinder 6 has been formed in this transverse beam 9, so that the fork cradle 2 is allowed to move directly on the curved surface 13 of the hydraulic cylinder 6. The groove 14 is illustrated in FIG. 3. The bearings between the fork cradle 2 and the hydraulic cylinder 6 preferably consists of slide bearings, and then the bearing surface may consist of the groove 14 in the uppermost transverse beam 9 of the fork cradle 2, with the bearing mounted on the curved surface 13 of the hydraulic cylinder 6, or accordingly, the curved surface 13 of the hydraulic cylinder 6 may serve as a bearing surface, with the bearing accordingly mounted in the upper transverse beam 9 of the fork cradle 2.

FIG. 2 additionally shows a support block 16 for receiving the moment generated by the transverse movement. The generated moment is transmitted to the structures of the hoisting cradle 4 by means of the support block 16 and the connected locking/adjuster blocks 15. The support block 16 is supported by the transverse lower beam 10 of the fork cradle 2. Using the assembly described above, the moment will be advantageously received, instead of being transmitted e.g. to the hydraulic cylinder 6 and the connected bearings of the fork cradle 2. The same construction eliminates any plays between the hoisting cradle 4 and the fork cradle 2.

FIG. 3 is an oblique bottom view of the fork cradle 2, in which the groove 14 positioned on top of the hydraulic cylinder 6 is better visible.

With the fork cradle 2 moving directly on the curved outer surface 13 of the hydraulic cylinder 6, there will be a reduced number of simpler transverse structures in the field of view of the driver of the forklift truck 1. At the same time, the visual obstruction caused by existing structures will be minimised. This provides enhanced visibility while allowing expenses to be cut down. The solution of the invention allows the dimension of the transverse construction to be reduced by about 20% compared to the solutions of the prior art references cited above. This yields an appreciable advantage. At the same time, the moments prevailing in the construction are reduced, as the distance between the force vector of the hydraulic cylinder 6, i.e. the central line, and the bearings of the fork cradle 2 are minimised. In this manner, the power of the hydraulic cylinder will be better utilised for the transfer operation, so that a cylinder with one degree lower power may even be sufficient.

FIG. 4 is a side view of the fork cradle 2. The fork cradle 2 is mounted on sliding bearings on the upper surface of a hydraulic cylinder 6 used for transverse shifting. The longitudinal axis of the same hydraulic cylinder 6 also serves as a pivoting axis when it is desirable to tilt the fork cradle 2 in the direction of movement of the forklift truck. The hoisting cradles are inclined upwardly by pushing the lower part of the fork cradle 2 forwardly by means of one or more hydraulic cylinders 18, so that the fork cradle is allowed to rotate about the central axis of the hydraulic cylinder 6 used for transverse shifting. Similarly, when the hydraulic cylinder 18 is reversed, the fork cradle 2 is allowed to rotate freely under the force of gravity into the opposite direction, about the hydraulic cylinder 6 used for transverse shifting.

With the fork cradle 2 journalled directly in the hydraulic cylinder connected to the hoisting cradle 4, the driver's blind area generated by the transverse blocks will be minimised. With the axis of inclination of the fork cradle 2 simultaneously converging with the central axis of the hydraulic cylinder 6 used for lateral movement, a very straightforward design is achieved for the piston of the hydraulic cylinder, since it does not call for separate bearings with respect to the fork cradle. The construction thus has economical manufacture and requires a substantially smaller number of construction parts than conventional constructions.

This invention has been explained by means of an example above. However, the example is by no means restrictive, but instead, the scope of protection of the invention is determined by the inventive idea defined in the following claims.

What is claimed is:

1. An assembly comprising:
a hoisting cradle and the fork cradle of a forklift truck, in which the fork cradle comprises two vertical beams and an upper horizontal beam and a lower horizontal beam, the beams forming a substantially rectangular construction, to which hoisting forks are attached, the hoisting cradle of comprising two substantially vertical beams, one substantially transverse beam and at least one substantially transverse hydraulic cylinder, and
a lower surface of the upper horizontal beam of the fork cradle matching the curved outer surface of the hydraulic cylinder, with bearings provided between the surfaces, and in that a central axis of the hydraulic cylinder converges with the tilting axis of the fork cradle.

2. An assembly as defined in claim 1, wherein 30-70%, preferably 40-60% and very advantageously 45-55% of the outer peripheral dimension of the outer surface of the hydraulic cylinder has been machined to form a bearing surface or the mounting surface of a bearing.

3. An assembly as defined in claim 1, wherein the bearings are slide bearings.

4. An assembly as defined in claim 1, wherein the lower horizontal beam of the hoisting cradle has further been provided with at least one support block and at least one locking/adjuster block for receiving the moment generated by the transverse movement.

5. An assembly as defined in claim 1, wherein tilting of the fork cradle is produced by means of one or more hydraulic cylinders.

6. A method for shifting a fork cradle of a forklift truck transversely and tilting it longitudinally, in which a hydraulic cylinder is used for shifting a fork cradle in the transverse direction, comprising:
shaping a lower surface of an upper substantially horizontal transverse beam of the fork cradle so as to match a curved upper surface of the hydraulic cylinder,
providing bearings between the lower surface of the substantially horizontal upper transverse beam of the fork cradle and the curved upper surface of the hydraulic cylinder,
providing movement of the fork cradle on bearings on the curved outer surface of the hydraulic cylinder,
providing tilting of the fork cradle about the central axis of the hydraulic cylinder.

7. A method as defined in claim 6, further comprising:
connecting at least one support block and two locking/adjuster blocks Ma substantially horizontal lower beam of a hoisting cradle in order to transmit the moment generated by the transverse movement to the construction of the hoisting cradle.
